(19) United States
(12) Patent Application Publication
(10) Pub. No.: US 2026/0185557 A1
(43) Pub. Date: Jul. 2, 2026

(54) BEARING ARRANGEMENT FOR WIND TURBINE MAIN SHAFT

(71) Applicant: The Timken Company, North Canton, OH (US)

(72) Inventors: Min Fang, Shanghai (CN); Jianguo Lu, Jiangsu (CN); Douglas R. Lucas, Uniontown, OH (US); Frederic Platz, Bergheim (FR); Dumitru-Dacian Ilie, Valenii De Munte (RO)

(21) Appl. No.: 18/855,592

(22) PCT Filed: Jul. 26, 2023
(86) PCT No.: PCT/CN2023/109274

§ 371 Date: Oct. 9, 2024

(51) Int. Cl. F16C 19/38

(52) U.S. Cl. CPC F16C 19/383; F16C 2360/31

(57) ABSTRACT

A wind turbine main shaft support configuration operable to provide rolling element support between a wind turbine main shaft and a housing about a central rotation axis. The wind turbine main shaft support configuration includes a group of tapered roller bearings supporting the main shaft or the housing for rotation with respect to the other about the central rotation axis. The group of tapered roller bearings includes a first tapered roller bearing and a second tapered roller bearing in a tandem arrangement with the first tapered roller bearing such that effective load centers of both the first and second tapered roller bearings are offset toward a first axial direction. Respective load lines from the first and second tapered roller bearings to the respective effective load centers are non-parallel.

### BACKGROUND

The present invention relates to bearing arrangements for supporting a main shaft of a wind turbine.

### SUMMARY

In one aspect, the invention provides a wind turbine main shaft support configuration operable to provide rolling element support to a wind turbine main shaft for rotation about a central rotation axis within a housing. The wind turbine main shaft support configuration includes an upwind set of tapered roller bearings rotatably supporting the main shaft about the central rotation axis and positioned adjacent an upwind end of the main shaft. The upwind set of tapered roller bearings includes first and second tapered roller bearings in a tandem arrangement in which respective effective load centers are both offset in an upwind axial direction. Respective load lines from the first and second tapered roller bearings to the respective effective load centers are non-parallel.

In another aspect, the invention provides a wind turbine main shaft support configuration operable to provide rolling element support between a wind turbine main shaft and a housing about a central rotation axis. The wind turbine main shaft support configuration includes a group of tapered roller bearings supporting the main shaft or the housing for rotation with respect to the other about the central rotation axis. The group of tapered roller bearings includes a first tapered roller bearing and a second tapered roller bearing in a tandem arrangement with the first tapered roller bearing such that effective load centers of both the first and second tapered roller bearings are offset toward a first axial direction. Respective load lines from the first and second tapered roller bearings to the respective effective load centers are non-parallel.

In yet another aspect, the invention provides a wind turbine drive train configuration. A blade hub includes a plurality of blade mounts, and the blade hub is rotatable about a central rotation axis. A generator has an input configured to be driven by rotation of the blade hub and operable in response to generate electrical power. A bearing arrangement includes a group of tapered roller bearings positioned about the central rotation axis. The group of tapered roller bearings includes a first tapered roller bearing and a second tapered roller bearing in a tandem arrangement with the first tapered roller bearing such that effective load centers of both the first and second tapered roller bearings are offset toward a first axial direction. Respective load lines from the first and second tapered roller bearings to the respective effective load centers are non-parallel.

### BRIEF DESCRIPTION OF THE DRAWINGS

FIG. 1 schematically illustrates a conventional wind turbine configuration, including a bearing-supported main shaft at an up-tower nacelle.

FIG. 2 is a cross-section of a wind turbine main shaft supported by a first single-row tapered roller bearing at an upwind side and a second single-row tapered roller bearing at a downwind side, consistent with the conventional configuration of FIG. 1.

FIG. 3 is a detail view of a portion of the bearing-supported main shaft of FIG. 2.

FIG. 4 is a partial cross-section view of a set of tapered roller bearings for supporting an upwind end of the main shaft in a wind turbine.

FIG. 5 is a schematic drawing of the set of tapered roller bearings of FIG. 4 positioned at the upwind end of the main shaft, with respective lines to the effective load centers. An additional tapered roller bearing is illustrated at the downwind end of the main shaft.

FIG. 6 is a detail cross-section view of the main shaft supported in a housing by the set of tapered roller bearings of FIGS. 4 and 5 and the additional downwind single-row tapered roller bearing of FIG. 5.

FIG. 7 is a schematic drawing of the main shaft supported at the upwind end by a set of tapered roller bearings according to another construction of the present disclosure, with respective lines to a coincident effective load center. An additional tapered roller bearing is illustrated at the downwind end of the main shaft.

FIG. 8 is a detail cross-section view of the main shaft supported in a housing in accordance with the configuration of FIG. 7, including the upwind set of tapered roller bearings and the additional downwind single-row tapered roller bearing.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

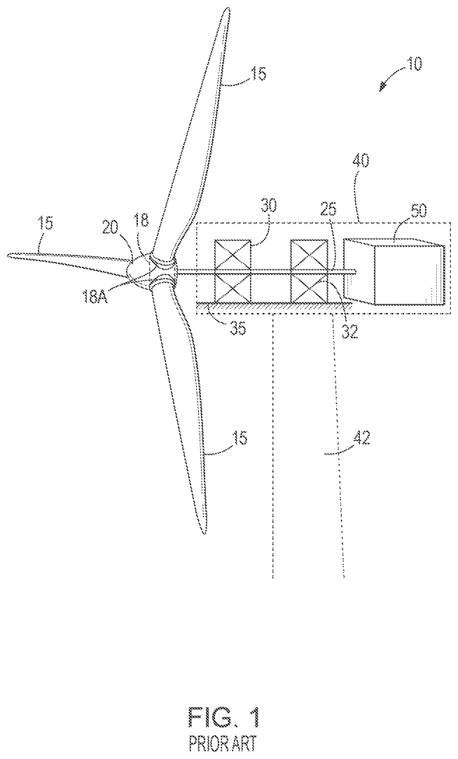

FIG. 1 illustrates a conventional wind turbine 10. The wind turbine 10 includes a set of turbine blades 15, for example three equally-spaced blades 15 all of which are coupled to a hub 18 provided with a plurality of blade mounts 18A (e.g., radial outward-facing surfaces including a bolt pattern). The leading or “upwind” side of the hub 18 can be covered by a nose cone 20. A main shaft 25 is coupled to the hub 18 such that the main shaft 25 and the hub 18 rotate together with the blades 15 in response to wind incident from the upwind side. The main shaft 25 forms part of a drive train configuration in which the main shaft 25 drives an electrical generator 50 operable to generate electrical power in response to rotational work input from the main shaft 25. The main shaft 25 can drive the generator 50 directly or through an intermediate gearbox (not shown). Between the hub 18 and the generator 50, the turbine main shaft 25 is supported relative to a stationary bedplate 35 by a plurality of rolling element bearings 30, 32 to provide multiple points of support. The bearings 30, 32 generally define an upwind support location and a downwind support location axially spaced from the upwind support location. As schematically illustrated by the broken lines, the components of the wind turbine drive train configuration rearward of the hub 18 are disposed in a nacelle 40 situated at the top of a tower 42.

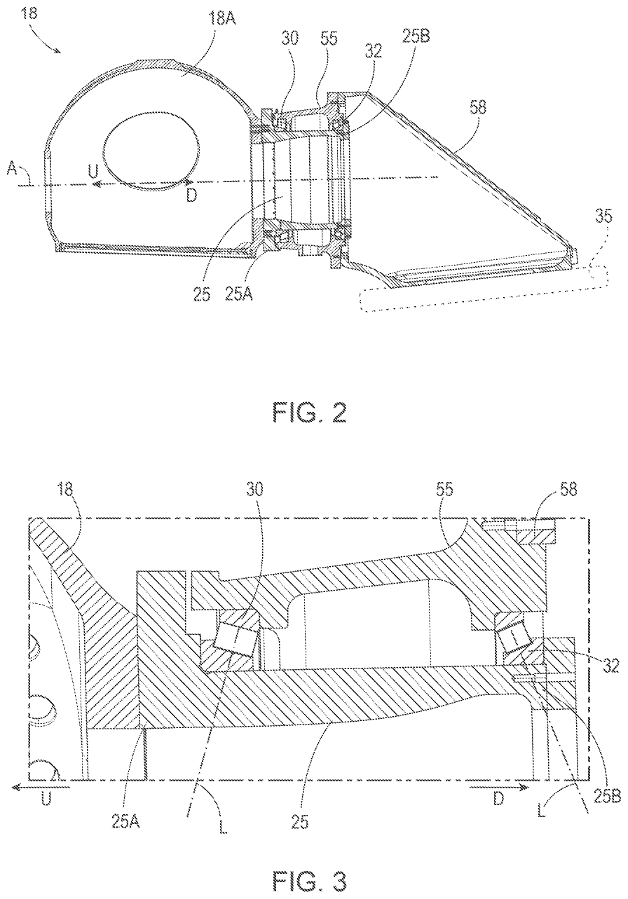

With respect to FIGS. 2 and 3, the main shaft 25 and supporting structure are shown in greater detail. As shown here, the main shaft 25 can include an upwind end 25A coupled (e.g., with threaded fasteners) to the hub 18 for rotation therewith, about the central rotation axis A. The upwind end 25A can include a radially-projecting flange. Opposite the upwind end 25A, the main shaft 25 includes a downwind end 25B, which is furthest from the blades 15 and hub 18 and nearest the generator 50 (FIG. 1). The outside of the main shaft 25 may be cylindrical from the upwind end 25A to the downwind end 25B, or may have different shapes in which at least a portion is tapered or otherwise provided with different radial dimensions. The bearings 30, 32 contact an outside surface of the main shaft 25 and support its rotation with respect to a bearing housing 55. The first or upwind bearing 30 is situated adjacent the upwind end 25A. The main shaft 25 and/or the bearing housing 55 can have designated bearing seats for one or both of the bearings 30, 32. The bearing housing 55 is fixedly secured (e.g., with threaded fasteners) to the bedplate 35. The bearing housing 55 can be secured to the bedplate 35 through a bedplate adapter or connection fixture 58. The downwind end 25B of the main shaft 25 is supported by the bearing 32 adjacent the connection between the bearing housing 55 and the bedplate adapter 58. The bearings 30, 32 are single-row tapered roller bearings configured to support radial and axial loading. In particular, the two bearings 30, 32 define oppositely-directed load lines L. The load line L of the upwind bearing 30 is angled toward the upwind direction U, and the load line L of the downwind bearing 32 is angled toward the downwind direction D.

Large wind turbines can have blades lengths of 50 meters or more, in some cases over 100 meters. In order to facilitate the generation of increased electrical power from the turbine's generator 50, blade lengths may be increased by turbine designers. However, increased blade length leads to higher loads at the main shaft 25 and bearings 30, 32 with higher load ratings—particularly the upwind bearing(s) 30 nearest the hub 18. Utilizing conventional main shaft bearing support configurations in newer, high-power (e.g., 18 MW) wind turbines can dictate bearing sizes that make cost effective manufacture and transport increasingly difficult or impossible. For example, bearing outer diameters greater than 3.5 meters (e.g., 3.7 to 4.3 meters for the main shaft of a 18 MW wind turbine) may be incompatible with available manufacturing equipment and unsuitable for various transportation (e.g., railway transport). In response, the present disclosure provides one or more unique bearing configurations that effectively reduce the required outer diameter for a given application (e.g., so as to not exceed 3.5 meters for a 18 MW wind turbine).

Tapered roller bearings have tapered rolling elements (“rollers”) situated between an inner race (“cone”) and an outer race (“cup”). Contact angles defined between a roller and the cone and cup raceways define an apex along the central rotation axis or “main” axis (axis A in the drawings of the present disclosure). The load on the bearing is considered to be normal to the supported shaft at a point of intersection between a load line and the main axis. The load line is projected normal to the cup raceway from the midpoint of the roller contact. Tapered roller bearings can be provided in a variety of configurations, including face-to-face (or “X”—load lines extend toward each other, and an integral double cone may be provided) and back-to-back (or “O”—load lines extend away from each other, and an integral double cup may be provided). In both of these configurations, axial loads in two different directions can be supported. Furthermore, tapered roller bearings can be provided in a tandem configuration in which two adjacent tapered roller bearings have load lines extending toward the same axial side such that the two tapered roller bearings distribute or share therebetween an axial load applied from one direction.

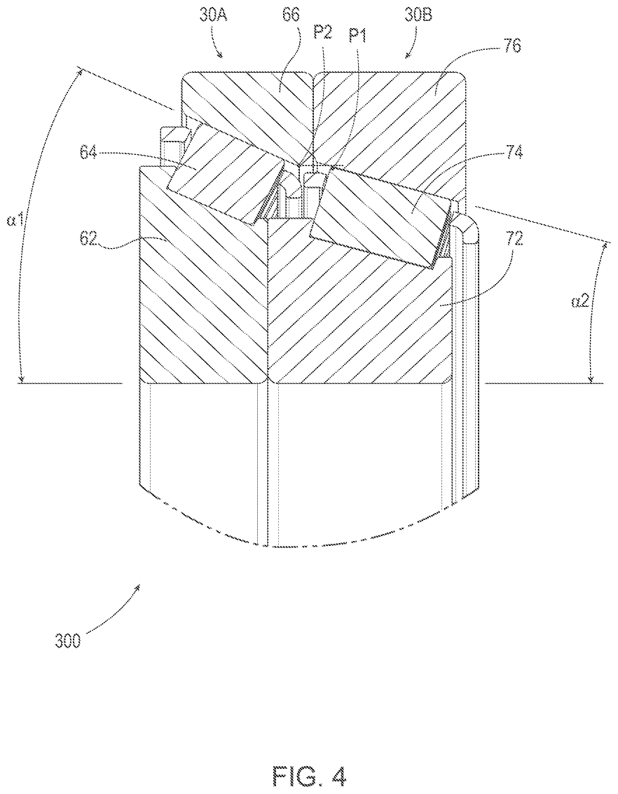

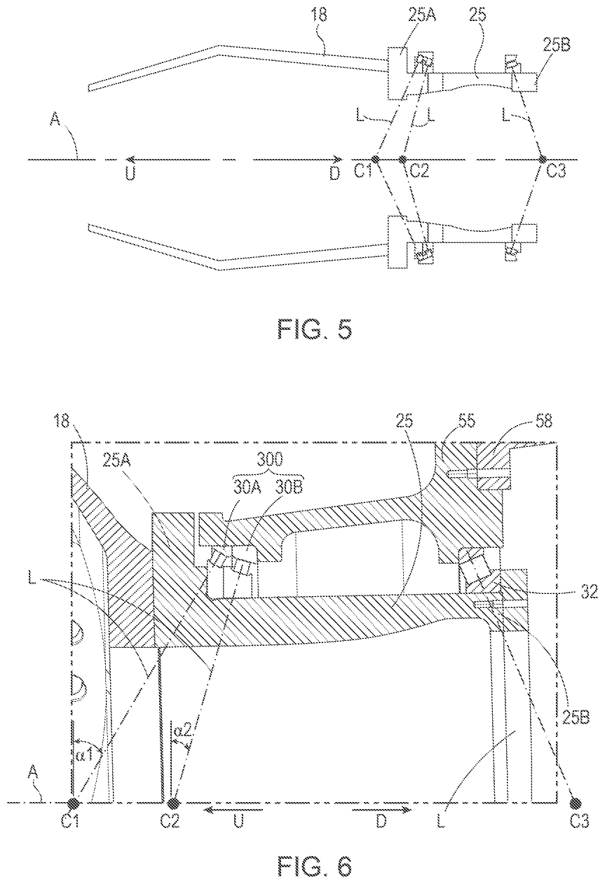

FIG. 4 illustrates a tandem tapered roller bearing set 300 for use within a wind turbine drive train configuration as shown in FIGS. 1-3. For example, the tandem tapered roller bearing set 300 can be positioned at the upwind side of a wind turbine main shaft 25. In particular, the tandem tapered roller bearing set 300 can replace the single-row tapered roller bearing 30 of FIGS. 1-3. This is shown in accompanying FIGS. 5 and 6. Due to the configuration of the first and second tapered roller bearings 30A, 30B of the tandem tapered roller bearing set 300, the first and second tapered roller bearings share or distribute therebetween an axial load applied to the main shaft 25 in the downwind direction D (from wind on the blades 15). Although not shown in FIG. 4, it will be appreciated that the load lines projected normal to the cup raceways from the respective midpoints of the roller contacts for both the first and second tapered roller bearings 30A, 30B extend down and to the left. Axial loads in the opposite direction are supported by the downwind tapered roller bearing 32.

With reference to FIG. 4 in particular, the first tapered roller bearing 30A includes a cone 62 providing an inner raceway for the tapered rolling elements 64 and a cup 66 providing an outer raceway for the tapered rolling elements 64. The cone 62 has an inner surface configured to mate with the outer surface of the main shaft 25. The cup 66 has an outer surface configured to mate with the inner surface of the bearing housing 55. The second tapered roller bearing 30B includes a cone 72 providing an inner raceway for the tapered rolling elements 74 and a cup 76 providing an outer raceway for the tapered rolling elements 74. The cone 72 has an inner surface configured to mate with the outer surface of the main shaft 25. The cup 76 has an outer surface configured to mate with the inner surface of the bearing housing 55. Although not required in all embodiments, the outside surfaces of the cups 66, 76 of the two bearings 30A, 30B can define a single shared outside diameter. As such, the bearing housing 55 can have a single pocket configured to receive both bearings 30A, 30B. The outside diameter of each bearing 30A, 30B can be 3.5 meters or less in some constructions. In other constructions, the outside diameter of one or both bearings 30A, 301B is over 3.5 meters. The cup 66 of the first bearing 30A and the cone 72 of the second bearing 30B can have an axial span that is shared, thus defining overlap where the cup 66 lies directly radially outside the cone 72. The small inside diameter of the cup 66 of the bearing 30A is larger than the work point diameter of the rollers 74 of the bearing 30B. In other words, the radially outermost point P1 (farthest from the central axis) occupied by the rollers 74 of the assembled bearing 30B is nearer the central axis than a radially innermost point P2 on the cup 66, and this eases the mounting of the tandem. A contact angle α1 defined by the raceway of the first cup 66 can be larger than a contact angle α2 defined by the raceway of the second cup 76. In some constructions, the contact angle α1 is 14-30 degrees, or more particularly, the contact angle α1 may be 23-29 degrees. In some constructions, the contact angle α2 is 10-26 degrees, or more particularly, the contact angle α2 may be 14-20 degrees. The rollers 64 of the first upwind bearing 30A have a shorter length than the rollers 74 of the second upwind bearing 30B. In other constructions, the rollers 64 are longer than the rollers 74, or the rollers 64, 74 have the same length. The rollers 64, 74 can be the same or different in cross-sectional area, taken at the midpoint of the roller length. The greater roller pitch circle diameter for the rollers 64 of the first bearing 30A can allow a greater number of rollers 64 than the number of rollers 74 of the second bearing 30B in order to provide a higher load rating.

Load lines L are defined for each of the bearings 30A, 30B, 32 as illustrated in FIGS. 5 and 6. Due to the difference in the contact angles α1, α2, the load lines of the first and second bearings 30A. 30B of the set 300 are not parallel. Rolling elements are not interchangeable between the first and second bearings 30A, 30B. The effective load center C1 of the first upwind bearing 30A of the set 300 is further in the upwind direction U than the effective load center C2 of the second upwind bearing 30B of the set 300, and the axial distance between the effective load centers C1, C2 increases in a direction toward the central rotation axis A. Thus, the first and second bearings 30A, 30B are not position-interchangeable without changing the position of the load centers C1, C2. The downwind bearing 32 defines a further effective load center C3. The effective load centers C1, C2, C3 all lie outside of an axial span or spread defined by the components of the group of bearings 30A, 30B, 32.

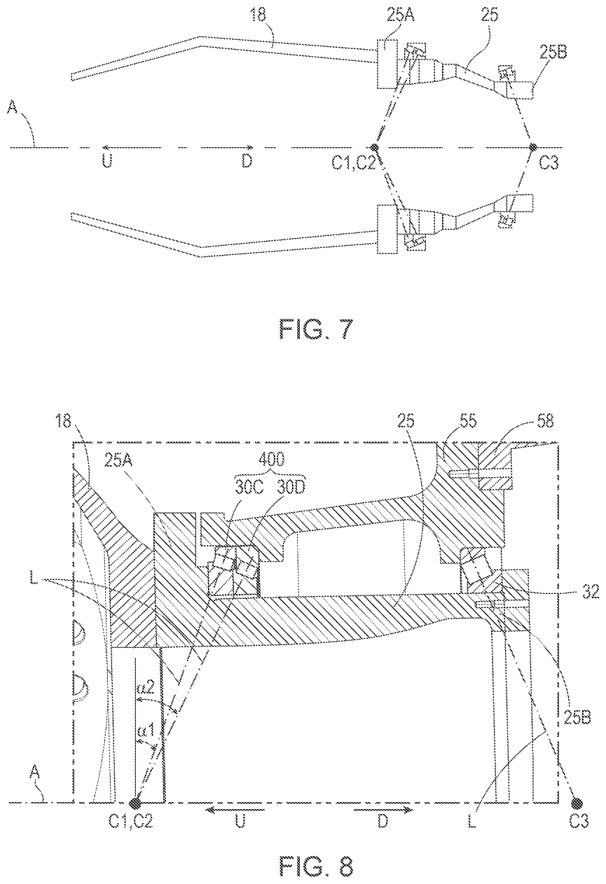

FIGS. 7 and 8 illustrate another embodiment of a tandem tapered roller bearing set 41K for use within a wind turbine drive train configuration as shown in FIGS. 1-3. For example, the tandem tapered roller bearing set 400 can be positioned at the upwind side of a wind turbine main shaft 25. In particular, the tandem tapered roller bearing set 400 can replace the single-row tapered roller bearing 30 of FIGS. 1-3, resulting in the configuration of FIGS. 7 and 8. Due to the configuration of the first and second tapered roller bearings 30C, 30D of the tandem tapered roller bearing set 400, the first and second tapered roller bearings share or distribute an axial load applied to the main shaft 25 in the downwind direction D (from wind on the blades 15). Axial loads in the opposite direction U are supported by the downwind tapered roller bearing 32. Features not described explicitly herein will be understood from the drawings and/or the above preceding description of FIGS. 1-3 and 4-6.

The contact angle α1 of the first bearing 30C of the set 400 can be smaller than the contact angle α2 of the second bearing 30D. The greater roller pitch circle diameter of the first bearing 30C can allow a greater number of rollers than the number of rollers of the second bearing 30D in order to provide a higher load rating. Load lines L are defined for each of the bearings 30C, 30D, 32 as illustrated in FIGS. 7 and 8. Due to the difference in the contact angles α1, α2, the load lines L for the first and second bearings 30C, 30D of the upwind bearing set 400 are not parallel. Rolling elements are not interchangeable between the first and second bearings 30C, 30D. In particular, the effective load center C1 of the first bearing 30C of the set 400 is coincident with the effective load center C2 of the second bearing 30D of the set 400. In other words, the effective load centers C1, C2 are represented by a single point along the central rotation axis A. This further improves the load sharing between the first and second bearings 30C, 30D of the upwind bearing set 400 compared to the bearing set 300 of FIGS. 4-6. The first and second bearings 30A, 30B are not position-interchangeable without changing the position of the load centers C1, C2. In some constructions, a method of manufacturing the bearing set 400, or the wind turbine drive train, can include selecting one bearing (e.g., the first bearing 30C or second bearing 30D) having a contact angle (e.g., α1 or α2) and then selecting the contact angle (e.g., α1 or α2) of the other bearing (e.g., the other one of the first bearing 30C and second bearing 30D) to result in coincident effective load centers C1, C2. The downwind bearing 32 defines a further effective load center C3.

In some constructions, the downwind bearing 30B of the upwind bearing set 300 (or the downwind bearing 30D of the upwind bearing set 400) can be constructed as a Two-Row Double-Outer Race (“TDO”) with the downwind bearing 32. A TDO bearing uses a shared double cup outer ring and two single cones as inner rings, with or without a spacer. The TDO designs are similar to what is shown in the preceding embodiments, but with greatly reduced axial spacing between the upwind and downwind bearing support positions, rather than spread apart by 1 or more meters distance (e.g., 1 m-4 m, or more). Axial spacing between the oppositely-angled bearings (e.g., between bearings 30B and 32, or between bearings 30D and 32) can be less than 1 m in some configurations, for example no axial spacing.

Although the bearing arrangements of the preceding embodiments are generally described for a rotating inner ring design where the housing is stationary and the shaft is rotating, features presented herein can also be applied for a rotating housing application where the inner rings and shaft are stationary. In such embodiments, the downwind bearing support position may be provided with a tandem bearing set according to the general description of the bearing sets 300, 400 of the preceding disclosure (e.g., rather than the upwind bearing support position as shown in those embodiments). As such, the bearing set 300 or 400 can be constructed as a mirror-image of that in the included drawings and moved to the position of the bearing 32 (which itself may be mirrored and positioned adjacent the upwind end).

Various changes are envisioned from the illustrated embodiments without deviating from the present invention. Various features of the invention are set forth in the following claims.

1. A wind turbine main shaft support configuration operable to provide rolling element support to a wind turbine main shaft for rotation about a central rotation axis within a housing, the wind turbine main shaft support configuration comprising:
an upwind set of tapered roller bearings rotatably supporting the main shaft about the central rotation axis and positioned adjacent an upwind end of the main shaft,
wherein the upwind set of tapered roller bearings includes first and second tapered roller bearings in a tandem arrangement in which respective effective load centers are both offset in an upwind axial direction, and
wherein respective load lines from the first and second tapered roller bearings to the respective effective load centers are non-parallel.

2. The wind turbine main shaft support configuration of claim 1, wherein the respective effective load centers are located at two separate points along the central rotation axis.

3. (canceled)

4. The wind turbine main shaft support configuration of claim 1, wherein the respective effective load centers are located at a common point along the central rotation axis.

5. The wind turbine main shaft support configuration of claim 1, wherein a radially outermost point occupied by a set of rollers of the second tapered roller bearing is nearer the central rotation axis than a radially innermost point on a cup of the first tapered roller bearing.

6. The wind turbine main shaft support configuration of claim 1, wherein a first contact angle defined by a raceway of a cup of the first tapered roller bearing is 14-30 degrees, and a second contact angle defined by a raceway of a cup of the second tapered roller bearing is 10-26 degrees.

7. The wind turbine main shaft support configuration of claim 6, wherein the first contact angle is 23-29 degrees, and the second contact angle is 14-20 degrees.

8. The wind turbine main shaft support configuration of claim 1, further comprising a downwind tapered roller bearing rotatably supporting the main shaft about the central rotation axis and positioned at a location spaced in a downwind axial direction from the upwind end, wherein a load line from the downwind tapered roller bearing extends to an effective load center spaced from the downwind tapered roller bearing in the downwind axial direction.

9. A wind turbine main shaft support configuration operable to provide rolling element support between a wind turbine main shaft and a housing about a central rotation axis, the wind turbine main shaft support configuration comprising:
a group of tapered roller bearings supporting the main shaft or the housing for rotation with respect to the other about the central rotation axis,
wherein the group of tapered roller bearings includes a first tapered roller bearing and a second tapered roller bearing in a tandem arrangement with the first tapered roller bearing such that effective load centers of both the first and second tapered roller bearings are offset toward a first axial direction, and
wherein respective load lines from the first and second tapered roller bearings to the respective effective load centers are non-parallel.

10. The wind turbine main shaft support configuration of claim 9, wherein the respective effective load centers are located at two separate points along the central rotation axis.

11. The wind turbine main shaft support configuration of claim 9, wherein the first axial direction is an upwind direction, and the first tapered roller bearing is positioned further in the upwind direction than the second tapered roller bearing.

12. The wind turbine main shaft support configuration of claim 11, wherein a first contact angle defined by a raceway of a cup of the first tapered roller bearing is smaller than a second contact angle defined by a raceway of a cup of the second tapered roller bearing.

13. The wind turbine main shaft support configuration of claim 12, wherein the first contact angle is 14-30 degrees, and the second contact angle is 10-26 degrees.

14. The wind turbine main shaft support configuration of claim 12, wherein the first contact angle is 23-29 degrees, and the second contact angle is 14-20 degrees.

15. The wind turbine main shaft support configuration of claim 11, wherein a radially outermost point occupied by a set of rollers of the second tapered roller bearing is nearer the central rotation axis than a radially innermost point on a cup of the first tapered roller bearing.

16. The wind turbine main shaft support configuration of claim 11, wherein the group of tapered roller bearings includes an additional tapered roller bearing positioned nearer a downwind end of the main shaft than the first and second tapered roller bearings, wherein a load line from the additional tapered roller bearing extends to an effective load center spaced from the additional tapered roller bearing in a second axial direction opposite the upwind direction.

17. The wind turbine main shaft support configuration of claim 9, wherein the respective effective load centers are located at a common point along the central rotation axis.

18-27. (canceled)

28. A wind turbine drive train configuration comprising the wind turbine main shaft support configuration of claim 9, and further comprising:
a blade hub including a plurality of blade mounts, the blade hub coupled to the wind turbine shaft and rotatable about the central rotation axis; and
a generator having an input configured to be driven by rotation of the blade hub and operable in response to generate electrical power.

29. The wind turbine drive train configuration of claim 28, wherein the generator is a 18 MW generator, and neither of the first and second tapered roller bearings has an outside diameter exceeding 3.5 meters.

30. A wind turbine drive train configuration comprising the wind turbine main shaft support configuration of claim 1, and further comprising:
a blade hub including a plurality of blade mounts, the blade hub coupled to the wind turbine shaft and rotatable about the central rotation axis; and
a generator having an input configured to be driven by rotation of the blade hub and operable in response to generate electrical power.

31. The wind turbine drive train configuration of claim 30, wherein the generator is a 18 MW generator, and neither of the first and second tapered roller bearings has an outside diameter exceeding 3.5 meters.
